(19) United States
(12) Patent Application Publication
(10) Pub. No.: US 2009/0016673 A1
(43) Pub. Date: Jan. 15, 2009

(54) OPTICAL COUPLING DEVICE AND METHOD FOR THE PRODUCTION THEREOF

(76) Inventor: Peter Selig, Hechingen (DE)

Correspondence Address: DICKSTEIN SHAPIRO LLP, 1825 EYE STREET NW, Washington, DC, 20006-5403, US

(21) Appl. No.: 12/162,310

(22) PCT Filed: Jan. 10, 2007
(86) PCT No.: PCT/EP07/00176

§ 371 Date: Jul. 25, 2008

(30) Foreign Application Priority Data
Jan. 27, 2006 (DE) 10-2006-004-014.7
Mar. 6, 2006 (DE) 10-2006-010-145.6

(51) Int. Cl. G02B 6/12

(52) U.S. Cl. 385/14

(57) ABSTRACT

An optical coupling device for the transmission of a signal from an input circuit to an output circuit. The optical coupling device comprises a transmission element connected to the input circuit to emit a signal, a reception element connected to the output circuit to receive the light signal and at least one printed circuit board for forming at least the input or the output circuit. The printed circuit board is provided between the transmission element and the reception element to electrically insulate the output circuit and the input circuit from each other. The light signal is transmitted from the transmission element to the reception element through the printed circuit board. Since commercially available printed circuit boards usually have a high dielectric strength, the resulting optocoupler is suitable for the electrical isolation of very high voltages such as those that frequently occur in electromedical devices.

### FIELD OF THE INVENTION

The invention relates to an electromedical device with an optical coupling device and a method for the production thereof.

### BACKGROUND OF THE INVENTION

In electronic devices generally, it is frequently necessary to insulate assemblies electrically from each other but still exchange data or signals between these assemblies. For electromedical devices, in particular high-frequency surgical devices, high insulation requirements have to be satisfied between the individual assemblies or circuits of the assemblies. In such applications, it is necessary to ensure not only faultless function of the devices, but also the safety of the patient in question. For example, during the electrical coagulation of tissue, significant currents and voltages are released and it must be possible for the surgeon to control them reliably at all times.

Optocouplers may be used for the purpose of electrical decoupling. Optocouplers connect an input circuit to an output circuit by means of optical signals. While there is electrical isolation between the input circuit and the output circuit, the signals are transmitted from the input circuit by means of a light-emitting component, received by a light-receiving component and converted appropriately in the output circuit.

Since, as mentioned above, medical technology places very high safety requirements on devices, very large mechanical clearances are required. Specifically, very large mechanical clearances are required between the electrical conductor tracks (i.e., from the input circuit to the output circuit). Further, a high dielectric strength of the corresponding device is also required. These safety requirements, which, for example, include the safe isolation of voltages of several kilovolts (KV) for the dielectric strength, necessitate special optocouplers.

The production of these special embodiments of optocouplers is complicated and cost-intensive. In addition, they frequently do not have standard dimensions and can only be used with difficulty in an automatic production process. Moreover, these optocouplers are very sensitive and are easily damaged in the soldering process and during positioning. This requires complex and expensive quality control.

It is the object of the invention to provide an electromedical device with an optocoupler which ensures the safe isolation of input and output currents, wherein the electromedical device can be produced simply and cost-effectively, preferably fully automatically.

### SUMMARY

In particular, the object of the invention may be achieved by an electromedical device with an optical coupling device for transmitting a signal from an input circuit to an output circuit, comprising a transmission element connected to the input circuit to emit a light signal, a reception element connected to the output circuit to receive the light signal and at least one printed circuit board for forming at least the input or the output circuit in that the printed circuit board is provided between the transmission element and the reception element to electrically insulate the output circuit and the input circuit from each other.

In the embodiments described herein, the printed circuit board, which usually has a high dielectric strength, is used to insulate individual circuits from each other. As with commercially available optocouplers, the non-electrical coupling takes place by means of the emission and reception of light signals. The optical coupling device disclosed herein can therefore be produced from commercially available components. The standard components are inexpensive to procure and can be easily mounted on the printed circuit board by means of commercially available insertion machines.

The mechanical clearance between the circuits can be varied by means of the thickness of the printed circuit board. Since printed circuit boards with different thicknesses are commercially available products, this enables a suitable dielectric strength to be achieved in a cost-effective way for every application by varying the thickness.

It is true that it is conceivable to provide the input circuit and output circuit and associated circuits on several separate printed circuit boards and then to arrange these in relation to each other in such a way that the reception element receives the light signal from the transmission element. For example, the transmission element with the input circuit could be arranged on a surface of a first printed circuit board and the reception element with the output circuit on a surface of a second printed circuit board. After the production of the two printed circuit boards, these are placed in relation to each other in such a way that the transmission and reception elements are separated by the two printed circuit boards and exchange light signals. However, it is advantageous for one printed circuit board with a first circuit-board surface and a second circuit-board surface to be placed between the transmission element and the reception element. In this arrangement, the input circuit with the transmission element is preferably formed on the first circuit-board surface and the output circuit with the reception element is formed on the second circuit-board surface. The reception element and the transmission element are therefore mounted alternately on the circuit-board surfaces in such a way that the light signal emitted by the transmission element passes through the printed circuit board to the reception element. In this way, reliable transmission of the light signal is ensured and there is no need for a plurality of printed circuit boards in a complex arrangement with respect to each other.

Preferably, the transmission element and/or the reception element comprise at least one SMD (surface mounted device) component. The so-called “surface-mounted” components do not have any wire leads which usually penetrate the printed circuit board. They are soldered directly onto the surface of the printed circuit board. This assembly of the printed circuit boards is preferable because a strict mechanical separation between the input circuit and the output circuit is achieved by the printed circuit board. Hence, even with a high packing density of components on the respective surfaces of the printed circuit board, the optical coupling device of the electromedical device can ensure a high dielectric strength and a sufficient clearance between the output circuit and the input circuit.

In one embodiment, a first plurality of SMD components for forming a first circuit, comprising the input circuit, and/or a second plurality of SMD components for forming a second circuit, comprising the output circuit, are provided on the at least one printed circuit board. This enables the packing density and the safety or dielectric strength of the printed circuit board to be further increased.

In another embodiment, the transmission element and the reception element each comprise an optically active side and are arranged in such a way that the optically active sides lie opposite each other with the printed circuit board placed therebetween. The frequently cuboidal transmission and reception elements are therefore embodied in such a way that only one side of the cuboid is optically active, that is, that only one side is suitable for transmitting or receiving the light signal. The other sides are optically blind. If the transmission element and the reception element are arranged so that the respective optically active side contacts the circuit-board surface directly or indirectly, the transmission element and the reception element are screened from their environment. The reception element cannot be subject to interference from external light sources and nor does the light signal emitted by the transmission element cause any interference to its environment.

In another embodiment, the transmission element comprises a light-emitting diode. In another embodiment, the reception element comprises a photodiode, a phototransistor or a phototrysistor.

According to the invention, it is possible for only one section of the at least one printed circuit board to be transparent and to be arranged so that the light emitted by the transmission element passes through this transparent section to the reception element. In one embodiment, however, the at least one printed circuit board is completely made of transparent material, in particular material containing epoxy resin. If the entire printed circuit board is transparent, there is no need for the possibly expensive provision of an individual transparent section. The printed circuit boards that may be used are so-called FR4 printed circuit boards. These are produced from a mixture of glass-fibre fabrics and epoxy resin and in addition to their light transmittance, have high fire resistance.

The at least one printed circuit board may have a high dielectric strength, in particular approximately 40 kilovolts (KV) per millimetre (mm). In this way, the electromedical device can ensure a high and sufficient dielectric strength even with low printed circuit board thicknesses.

The object described above is also achieved by a method for the production of an electromedical device with an optical coupling device, wherein the method comprises the following steps:
providing at least one optically transparent section on a printed circuit board,
mounting of an optical transmission element on a first surface of the printed circuit board,
mounting of an optical reception element on a second surface of the printed circuit board, wherein the transmission element and the reception element are mounted in such a way that the reception element receives light signals from the transmission element through the optically transparent section.

As with the device, the central idea of the method is that skilful mounting of standard components on a printed circuit board creates an optocoupler for a electromedical device, which satisfies high requirements with respect to dielectric strength. The transmission element and the reception element are preferably mounted opposite each other each on one side of the printed circuit board. The light signals transmitted from the transmission element penetrate the printed circuit board and are received by the reception element.

Preferably, the method comprises the mounting of a plurality of electrical components, in particular SMD components, and conductor tracks on the circuit-board surfaces for forming circuits connected to the transmission element and the reception element. The use of the SMD components makes machine production particularly simple and also offers safety with respect to the dielectric strength of the optocoupler, since the individual SMD components are completely mechanically separated from each other by the printed circuit board. Conductor tracks and components can be produced efficiently using conventional methods on the opposite sides of the printed circuit board and respectively forming electrically isolated circuits for the electromedical device.

### BRIEF DESCRIPTION OF THE DRAWINGS

In the following, the invention will now be described below with reference to an exemplary embodiment which will be explained in more detail with reference to the enclosed drawings:

FIG. 1 illustrates a schematic section through an optical coupling device according to the invention.

FIG. 2 illustrates a block diagram with a transmission and reception unit.

FIGS. 3a and 3b illustrate a schematic representation of an upper or lower side of a printed circuit board fitted with components.

### DETAILED DESCRIPTION OF THE INVENTION

In the following description, the same reference numbers are used for identical parts and parts with identical functions.

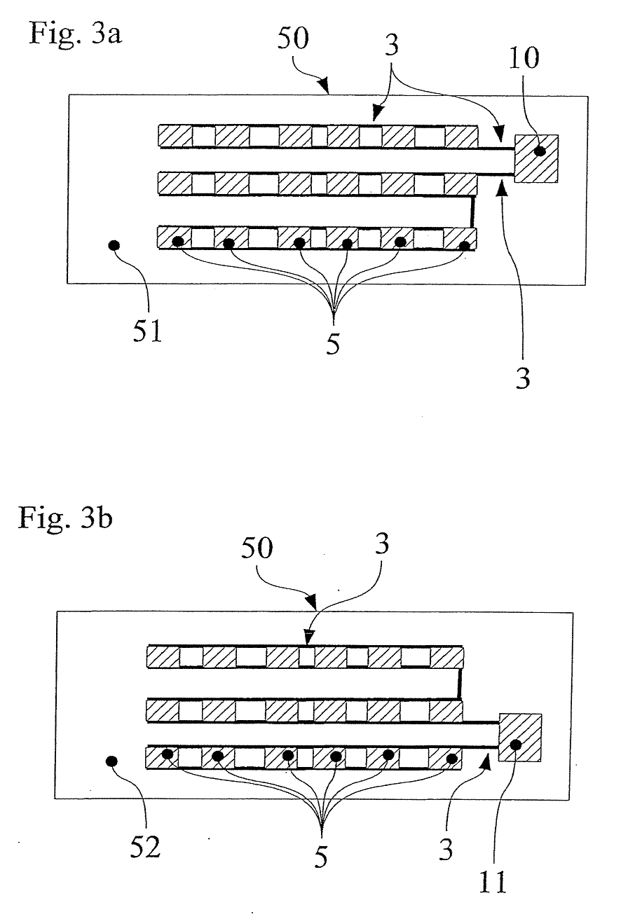

In one exemplary embodiment of the invention, an electromedical device with an optical coupling device is described. The electromedical device is a device for high-frequency surgery in which high-frequency alternating currents are used to cut or coagulate tissue. A control circuit or input circuit controls the alternating current or output circuit in such a way that a suitable current intensity and frequency is present for each application. In order to ensure reliable functioning of the high-frequency surgery device, the output circuit and the input circuit must be electrically isolated from each other. This is achieved by an optical coupling device according to the invention as shown in FIGS. 3a and 3b. FIGS. 3a and 3b show a top view of a first circuit-board surface 51 (FIG. 3a) and a second circuit-board surface 52 (FIG. 3b) of a printed circuit board 50. In the schematic representation in FIG. 3a, a plurality of electrical components 5 is interconnected by conductor tracks 3. The electronic components 5 are SMD components (surface mounted devices), which are soldered onto the printed circuit board 50, for example, by means of a reflow method.

Also connected to the conductor tracks 3 and embodied as an SMD component is the transmission element 10.

On the other side of the printed circuit board 50, namely on the second circuit-board surface 52, there is a reception element 11 (see FIG. 3b), which is opposite the transmission element 10. This reception element is connected by conductor tracks 3 to a plurality of components 5, which are also SMD components.

The plurality of electrical components of the first circuit-board surface 51 and the second circuit-board surface 52 form, inter alia, a control device 30 or a reception device 40 (see FIG. 2). This control device 40 comprises an input circuit, which is connected to the transmission element 10. As FIG. 2 shows, light signals 1 are emitted by the transmission unit 10 in accordance with the input circuit. These light signals 1 are received by the reception element 11, processed by the reception device 40 converted and input into an output circuit. The light signals 1 can be both analog-coded and digital-coded.

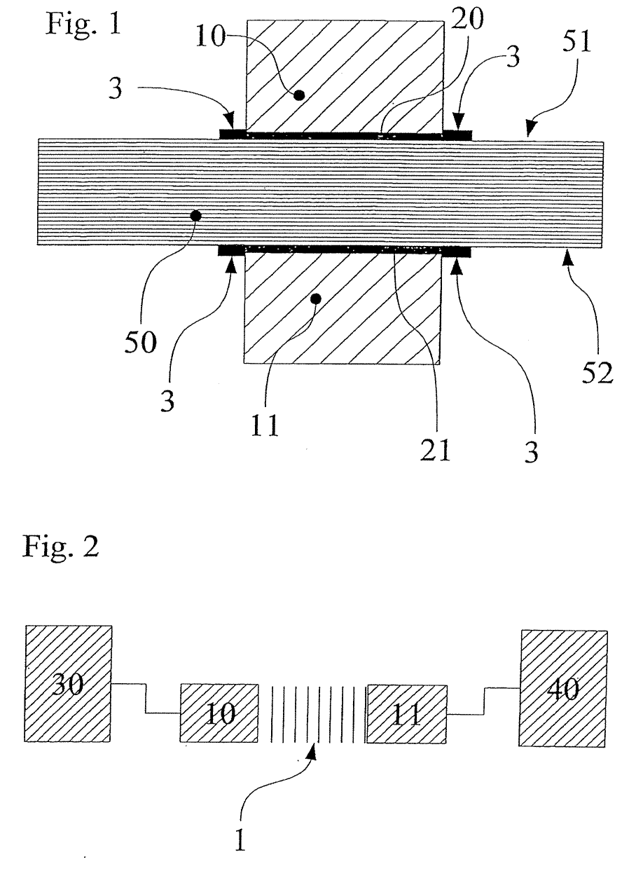

According to the invention, these light signals are transmitted by the transparent printed circuit board 50. This is shown in the partial cross section in FIG. 1 through the printed circuit board 50. As already described, the transmission element 10 and the reception element 12 are opposite each other. They are each secured on the first circuit-board surface 51 and the second circuit-board surface 52. For connection to the input circuit or output circuit, two conductor tracks 3 are provided on the sides of the transmission and reception elements 10, 11.

The transmission element 10, which is a light-emitting diode, comprises exactly one optically active side 20. This first optically active side 20 is arranged opposite a second optically active side 21 of the reception element 11. The reception element 11 also comprises only the one optically active side 21. The optically active sides 20, 21 are each arranged directly on the first circuit-board surface 51 and the second circuit-board surface 52 and ensure reliable transmission of the light signals 1 through the printed circuit board 50. In addition, the optically active sides 20, 21 are screened from external influences by direct contact with the printed circuit board 50.

1. An electromedical device with an optical coupling device for the transmission of a signal from an input circuit to an output circuit, comprising
a transmission element connected to the input circuit to emit a light signal;
a reception element connected to the output circuit to receive the light signal; and
at least one printed circuit board for forming at least the input or the output circuit, wherein the printed circuit board is provided between the transmission element and the reception element to electrically insulate the output circuit and the input circuit from each other.

2. The electromedical device with an optical coupling device according to claim 1, wherein exactly one printed circuit board with a first circuit-board surface and a second circuit-board surface is provided between the transmission element and the reception element, and wherein the input circuit with the transmission element is formed on the first circuit-board surface and the output circuit on the second circuit-board surface.

3. The electromedical device with an optical coupling device according to claim 1, wherein the transmission element comprises at least one SMD component.

4. The electromedical device with an optical coupling device according to claim 1, wherein the at least one printed circuit board is a first plurality of SMD components for forming a first circuit, comprising the input circuit, or a second plurality of SMD components for forming a second circuit, comprising the output circuit.

5. The electromedical device with an optical coupling device according to claim 1, wherein the transmission element and the reception element each comprise an optically active side and are arranged in such a way that the optically active sides are located opposite each other with the printed circuit board being placed therebetween.

6. The electromedical device with an optical coupling device according to claim 1, wherein the transmission element comprises a light-emitting diode.

7. The electromedical device with an optical coupling device according to claim 1, wherein the reception element comprises a photodiode, a phototransistor or a phototrysistor.

8. The electromedical device with an optical coupling device according to claim 1, wherein the at least one printed circuit board is made of transparent material.

9. The electromedical device with an optical coupling device according to claim 1, wherein the at least one printed circuit board has a high dielectric strength.

10. A method of fabricating an electromedical device having an optical coupling device, comprising the steps of:
providing at least one optically transparent section on a printed circuit board;
mounting of an optical transmission element on a first circuit-board surface of the printed circuit board; and
mounting an optical reception element on a second circuit-board surface of the printed circuit board; and
wherein the transmission element and the reception element are mounted such that the reception element receives light signals from the transmission element through the optically transparent section.

11. The method according to claim 10, further comprising forming conductor tracks, on the circuit-board surfaces, connected to the transmission element and the reception element.

12. The electromedical device with an optical coupling device according to claim 1, wherein the reception element comprises at least one SMD component.

13. The electromedical device with an optical coupling device according to claim 8, wherein the printed circuit board is made of material containing epoxy resin.

14. The electromedical device with an optical coupling device according to claim 9, wherein the dilectric strength is approximately 40 kv/mm per mm.
